(19) United States
(12) Patent Application Publication
(10) Pub. No.: US 2016/0193824 A1
(43) Pub. Date: Jul. 7, 2016

(54) MICRO FORMING DEVICES AND SYSTEMS AND USES THEREOF

(71) Applicant: TUFTS UNIVERSITY, Medford, MA (US)

(72) Inventors: Thomas P JAMES, Boxford, MA (US); Robert D. WHITE, Lexington, MA (US); Eric C. SCHMITT, Falmouth, MA (US)

(21) Appl. No.: 14/910,957

(22) PCT Filed: Aug. 12, 2014
(86) PCT No.: PCT/US14/50753

§ 371 Date: Feb. 8, 2016

Related U.S. Application Data
(60) Provisional application No. 61/865,018, filed on Aug. 12, 2013.

(51) Int. Cl. B41F 1/18

(52) U.S. Cl. CPC B41F 1/18

(57) ABSTRACT

The present disclosure relates to micro-forming (e.g., micro-punches) devices and uses thereof. In particular, the present invention relates micro-forming devices and systems made using lithographic techniques, the use of such devices in fabricating a variety of materials.

The present application claims priority to U.S. Provisional Patent Application Ser. No. 61/865,018, filed Aug. 12, 2013, the disclosure of which is herein incorporated by reference in its entirety.

### FIELD OF THE INVENTION

The present disclosure relates to micro-forming (e.g., micro-punches) devices and uses thereof. In particular, the present invention relates micro-forming devices and systems made using lithographic techniques, the use of such devices in fabricating a variety of materials.

### BACKGROUND OF THE INVENTION

Microforming is a rapidly developing field, driven by at least two compelling forces: (1) Reducing the size of components and related devices from the macro to microscale, and (2) Bridging the gap between nano devices and the macro environment, which requires a micro-interface. The term “microforming” encompasses the common macro-processes, but at a microscale, such as micro-machining, micro-casting, micro-molding, micro-bending, and micro-punching (-blanking) to name a few. Of these microforming processes, micro-punching is less developed, especially when you consider the prevalence of punching in everyday high volume sheet metal manufacturing. Contemporary methods to produce micro-punches, for use in micro-punching die sets, are based on traditional methods whereby the punch is a separate component from the die block. The punches typically start with a small diameter rod on the millimeter scale and then through progressive machining and precision grinding are reduced to a diameter on the microscale. Micro-punches fabricated in this manner create a hole in the workpiece that is circular. Published research has demonstrated single hole micro-punching in metal foils where the holes were approximately 50 um in diameter.

Additional methods for microforming and machining material are needed.

### SUMMARY OF THE INVENTION

The present disclosure relates to micro-forming (e.g., micro-punches) devices and uses thereof. In particular, the present invention relates micro-forming devices and systems made using lithographic techniques, the use of such devices in fabricating a variety of materials, including substrates for tissue engineering, microscale electrical connectors, and micro-filtration.

Embodiments of the present invention provide devices, systems, and methods for micro-forming (e.g., micro-punching) substrates for use in a variety of applications and industries. For example, in some embodiments, the present invention provides a microforming device, comprising: An integrated two piece die set comprising a punch lithographed component and a hole lithographed component. In some embodiments, the punch component is glass, silicon, or metal. In some embodiments, the punch and/or hole components are coated with an anti-stiction coating (e.g., a self-assembled monolayer). In some embodiments, the micro-punch comprises an alignment component (e.g., markings for optical alignment, e.g., fiducial). In some embodiments, the die set is optically aligned by looking through the hole in the female die while raising the male (punch) die into position without the use of fiduciary marks. In some embodiments, the die block has multiple micro-punches configured to produce one or more (e.g., 2, 3, 4, 5, 10, 15, or more) holes simultaneously. In some embodiments, the two or more holes are 100 μm or less apart (e.g., 75 μm, 50 μm, 25 μm, 15 μm, 10 μm, 5 μm, 1 μm or less). In some embodiments, the die block further comprises a liquid nitrogen cooling component.

Additional embodiments provide uses and methods of using the above mentioned die block to generate one or more holes in a material (e.g., biodegradable materials such as, e.g., polycaprolactone (PCL), plastics, tissues, and metals). In some embodiments, the material is a substrate for cell or tissue growth or an electrical connector. In some embodiments, the material is stretched over said female die prior to generating the one or more holes.

In some embodiments, the present invention provides a system, comprising a substrate for cell or tissue growth generated by the aforementioned methods; and a cell or tissue embedded therein.

In further embodiments, the present invention provides a method of manufacturing a die set, comprising: a) removing material from a first substrate using a lithographic technique to generate a male die; and b) removing material from a second substrate using a lithographic technique to generate a female die. In some embodiments, the substrate is, for example, metal, glass, or silicon. In some embodiments, the lithographic technique is for example, masking, chemical etching, or deep reactive ion etching (DRIE).

Additional embodiments are described herein.

### DESCRIPTION OF THE FIGURES

FIG. 1 shows a schematic of a micro-punch of embodiments of the present disclosure.

FIG. 2 shows a schematic of a micro-punch of embodiments of the present disclosure.

FIG. 3 shows a male punch made by lithographic processes and a hole in a female die made by laser cutting.

FIG. 4 shows an exemplary system of embodiments of the present disclosure.

FIG. 5 shows an exemplary system of embodiments of the present disclosure.

FIG. 6 shows a schematic of construction of a support for tissue growth.

FIG. 7 shows a schematic of construction of a support for tissue growth.

FIG. 8 shows fabrication of a micro-part using a progressive die.

FIG. 9 shows an exemplary spherical bearing and vacuum arrangement used to achieve parallelism between the mating dies.

FIG. 10 shows an exemplary micro-stamping press showing X-Y-O stages used for male to female die alignment, spherical bearing used for adjusting parallelism between the male-female die halves, Z axis staging used to control movement of the male die in the punching direction, and several components comprising the custom microscope system used for direct die set alignment.

FIG. 11 shows (A) Depiction (not to scale) of the direct alignment method used to center the punch within the hole and (B) Actual design of the components comprising the direct alignment system.

FIG. 12 shows an optical microscope image (200×) captured by a digital camera during alignment of a 200 μm punch. The darkened doughnut shaped boundary is the clearance gap between the male and female dies.

FIG. 13 shows a diagram of a die block with vacuum channel and holes, which are used to secure the die in place after establishing location with the guide pins.

FIG. 14 shows a stamping die arrangement that utilizes a stripper plate to hold the workpiece material in place.

FIG. 15 shows vacuum porting in the female die block that was used to secure both the die and the workpiece material during stamping.

FIG. 16 shows an exemplary workpiece material holder with X-Y-Z precision stages for movement of the material within the die set.

FIG. 17 shows movement of the material holder in the Z direction, above the plane of the female die, which causes a planar tensile force, F, in the workpiece.

FIG. 18 shows a tapered hole in the female die assisted with trapping the punch out, thus preventing it from sticking to the end of the punch and being lifted out of the hole.

FIG. 19 shows that a minimum web thickness of between 5 μm and 10 μm was achieved when micro-punching adjacent 200 μm holes in 25 μm thick copper foil.

FIG. 20 shows room temperature micro-punching of a 200 μm hole in 37 μm thick poly-caprolactone resulting in a thin web of material that stretched between the die and punch, which prevented the punch-out from fully detaching.

FIG. 21 shows 200 μm diameter holes (62% porosity, 21% die clearance) created by micro-punching 33 μm thick poly-caprolactone with die sets cooled by liquid nitrogen to below the polymer's glass transition temperature.

FIG. 22 shows a design and fabricated components comprising a liquid nitrogen reservoir used to cool the male die and vacuum block.

FIG. 23 shows a section view of a die set assembly, highlighting the key components for liquid nitrogen cooling of the die blocks.

### DETAILED DESCRIPTION

The present disclosure relates to micro-forming (e.g., micro-punches) devices and uses thereof. In particular, the present invention relates micro-forming devices and systems made using lithographic techniques, the use of such devices in fabricating a variety of materials.

Microforming is a rapidly developing field, driven by at least two compelling forces: (1) Reducing the size of components and related devices from the macro to microscale, and (2) Bridging the gap between nano devices and the macro environment, which requires a micro-interface. The term “microforming” encompasses the common macro-processes, but at a microscale, such as micro-machining, micro-casting, micro-molding, micro-bending, and micro-stamping (-blanking) (-punching) to name a few. Of these microforming processes, micro-stamping is the least developed, especially considering the prevalence of stamping operations in contemporary sheet metal manufacturing.

In some embodiments, the micro-stamping press provides an “engineered” micro-architecture, meaning the resulting geometry is designed and manufactured to specification, as opposed to generating random porosity through, for example, a solvent based process resulting in “sponge like” constructs. Technologies for engineering such as laser cutting, additive processes, and micro-molding have limitations when compared to micro-stamping, as described below.

Laser Cutting: With laser cutting, holes are formed individually as either the laser or workpiece table translates to outline the perimeter of the hole feature and consequently the process is relatively slow. Faster cutting requires more heat and in plastics heat from the laser melts the thin sections between holes, which can limit feature size and porosity. Porosity is typically stated as a percentage, referring to a ratio of the hole area to initial area. In applications such as filters and scaffolds for tissue engineering, higher porosity (>50%) is preferred. High porosity requires intact thin webs between adjacent holes. An additional problem when cutting holes with a laser is that the side walls exhibit a taper, with the entrance hole of the laser larger than the exit hole as the beam is attenuated at greater depths. Taper on the sides of the holes limits maximum porosity as the webs between adjacent holes become thicker at the exit side of the laser.

Additive Processes: In additive processes, such as deposition techniques like curing a powder or liquid with a laser or secreting a fast setting liquid polymer through a micro-nozzle, manufacturing is relatively slow when compared to punching. In re-melt additive processes like “printing”, the choice of raw material is limited by the melt-solidification characteristics of the raw material e.g., only certain materials are suitable for secretion through micro-nozzles. For example, the entire thermoset category of plastics is eliminated as the materials cannot be re-melted. In addition, composite materials are normally unsuitable for additive processes. Alternatively, in micro-stamping the host material can be produced from contemporary high volume manufacturing processes prior to formation of the hole geometry. For example, in some embodiments (See e.g., below description), poly-caprolactone (PCL), a biocompatible, biodegradable plastic used in tissue scaffold development, was formed using hot melt extrusion to efficiently produce a continuous plastic film prior to punching the micro-hole geometry.

Micro-molding: With molding, there are less material restrictions than with additive processes, but there are limitations related to the geometry that can be constructed. In particular, it is difficult to produce thick sections with small features e.g., “high aspect ratio” geometry because the finished part is inclined to stick to the male die. Consider for example a 100 um thick plastic sheet with 50 um diameter holes. If the holes are spaced too closely it is difficult to remove the sample from the die without tearing the thin webs between holes. This limits the degree of porosity achievable. Draft can be added to assist with removing the sample from the die, but this creates tapered geometry, which is similar to the problem encountered with laser cutting. Finally, micro-molding is not a continuous process as the completed component must be removed from the die after each cycle, thus it is comparatively quite slow to micro-stamping.

Stamping microscale holes has the advantage of high speed production because it can be a continuous operation as the material is fed into the die as a long strip. In addition, multiple holes can be punched in a single stroke of the machine, the holes are not tapered, and the holes can be punched very close together without tearing the webs between holes, thus achieving a high degree of porosity.

Embodiments of the present invention provide micro-fabricated devices (e.g., micro-punches). In some embodiments, the present disclosure provides a micro-stamping press that performs several microforming processes, e.g., micro-punching round and irregular shaped holes, micro-blanking, and micro-bending with both compound and progressive micro-fabricated die sets. During development of embodiments described herein, devices with the following improvements were developed:

Vacuum activated spherical bearing for alignment of parallelism between the male and female die planes

Direct, active alignment of male and female die features through real time microscopic viewing

Vacuum activated clamping of dies and workpiece material

Workpiece holder capable of applying tension to the material

Elimination of the stripper plate (blank holder) so that shorter punches can be used

Tapered holes in the female die to capture the punched out material

Liquid nitrogen cooling of the die sets to facilitate micro-punching polymers in a brittle state by reducing the temperature below the glass transition point

Controlling the buildup of condensation and frost by pressurizing the die block system with a gas, e.g., dry nitrogen gas

Embodiments of the present invention provide a micro-stamping press that has been used to punch round holes between 100 to 200 micrometers (um) in diameter in thin plastic films and metal foils where material thickness was less than 50 um, thus two of three dimensions were less than 1.0 mm. The press has also been used to punch 200 um slots in copper foil by connecting a series of holes.

In some embodiments, a die set that punches and bends metal foil in a progressive method to produce a micro-angle bracket by a combination of punching, blanking, and bending is provided.

Embodiments of the present disclosure describe a micro-punch, integral to the die block. Rather than starting with the macro-machining processes used in typical die set development, micro-fabrication techniques that presently dominate in the fabrication of micro-electronics, the so called “lithographic” processes for MEMS (micro electromechanical systems), were applied to the construction of the male (punch side) and female (hole side) of micro-die sets such that the punch is integral with the die block (e.g., a separate punch is not inserted into a hole in the die block, but rather the punch is formed integral with/to the die block). Benefits of this approach include, but are not limited to: (1) very small feature size, e.g., less than 500 μm with very high precision for feature size and very high precision between features, which is important for alignment of the male and female die halves, (2) A punch with the ability to make non-circular holes, which is important for punching and forming components within the die, especially for micro-parts with a high aspect ratio, (3) a punch with the ability to make more than one punch on the die and therefore more than one hole when punching, e.g., improved productivity and manufacturing capability (blanking and bending), (4) a punch with the ability to make punches very close together as the punch is integral with the die block—important when making micro-filters where you want a lot of holes and thin webs, e.g., achieving a high porosity, (5) low cost as many die sets can be made on one base material (e.g., silicon wafer). In addition to making a compound die set, where one stroke of the press creates one hole or one pattern of holes, micro-progressive die sets can be made to produce several holes or forming operations where the material strip is moved during each stroke of the die (e.g., in the manufacture of micro-electrical connectors)

The micro-forming systems and devices of embodiments of the present disclosure are suitable for punching one or a plurality of holes (e.g., 2 or more, 3 or more, 4 or more, 5 or more, 10 or more, etc.) simultaneously in a variety of substrates for a variety of applications. In some embodiments, holes are on the micrometer scale (e.g., 1 to 1000 μm, 10 to μm, 10 to 500 μm, 50 to 500 μm, or 50 to 250 μm, although other sizes are contemplated). The devices and systems described herein provide the advantage of being able to punch or form a plurality of features close together (e.g., less that 100 μm apart, less than 75 μm apart, less than 50 μm apart, less than 25 μm apart, less than 15 μm apart, less than 10 μm apart, less than 5 μm apart, or less than 1 μm apart).

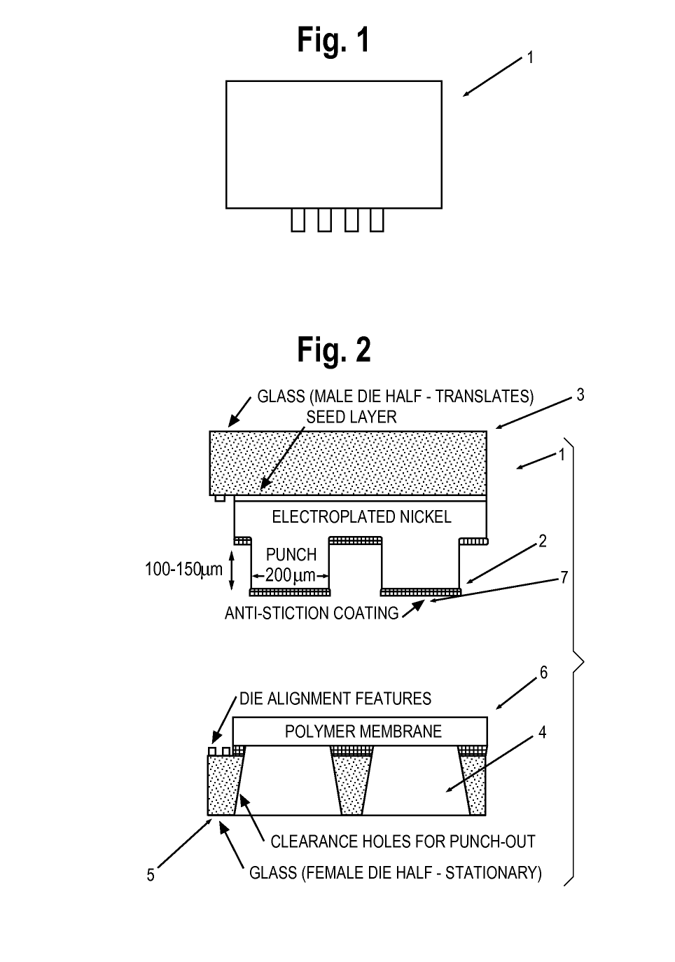

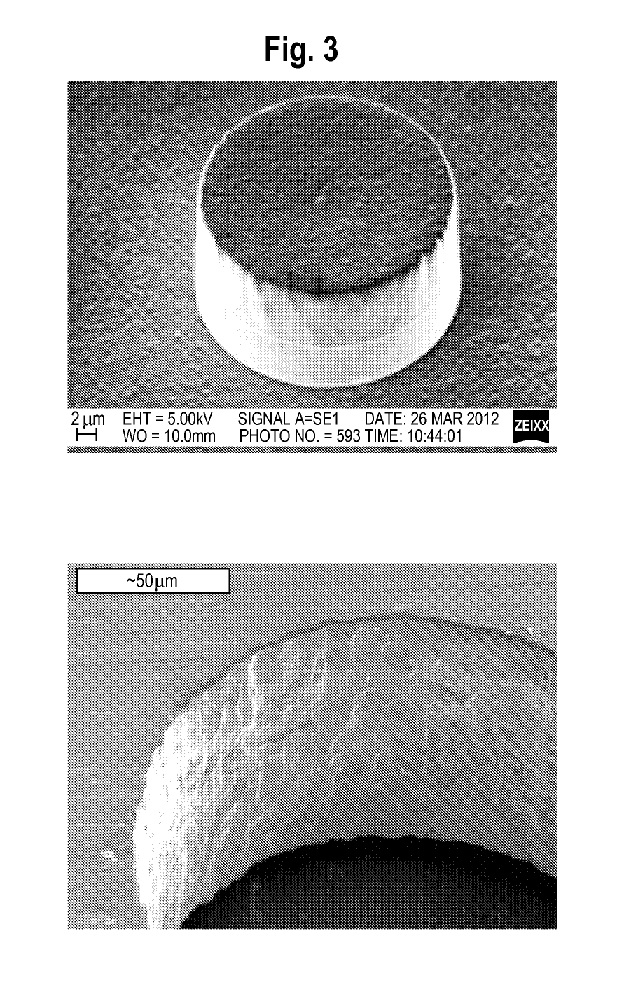

FIGS. 1 and 2 shows a micro-punch 1 of embodiments of the present invention. The micro-punch comprises a male punch 2 and a female die half 5. The micro-punch is optionally coated with an anti-stiction coating 7. The micro-punch optionally comprises a glass male die half 3 and clearance holes 4. FIG. 2 shows a polymeric substrate 6 in the die.

In some embodiments, the micro-stamping press uses die sets that are produced by lithographic processes, such as deep reactive ion etching (DRIE), deposition, etching, and electroplating as well as by laser cutting and micro-machining, although other methods of producing die sets are specifically contemplated. With lithographic processes, the most common working materials are silicon and glass wafers. They are readily available at low cost and can facilitate the mass production of several die sets on one wafer, which after manufacturing can be sectioned into individual dies. In general, silicon wafers are less than 1 mm thick and glass wafers are approximately 1.5 mm thick.

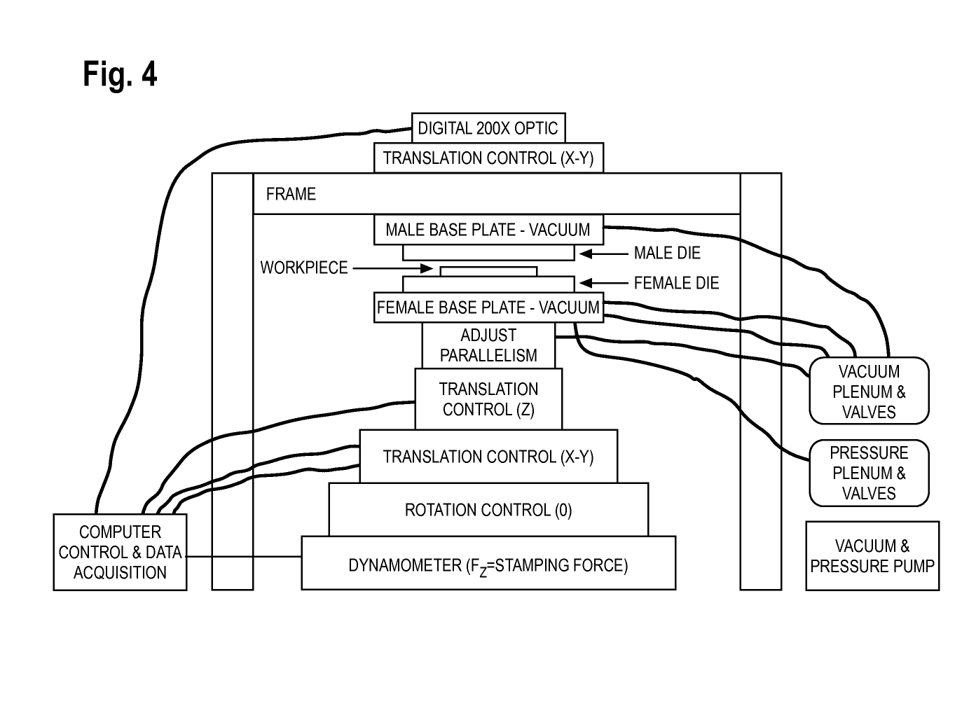

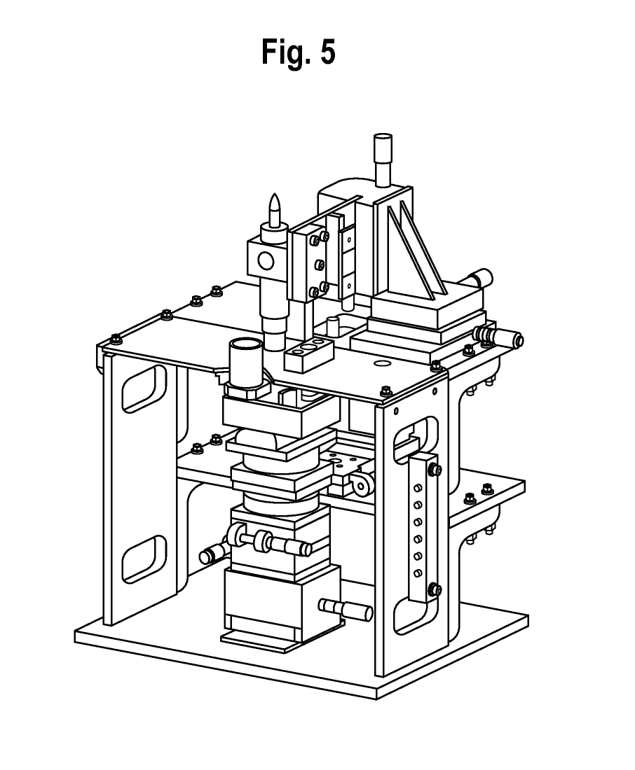

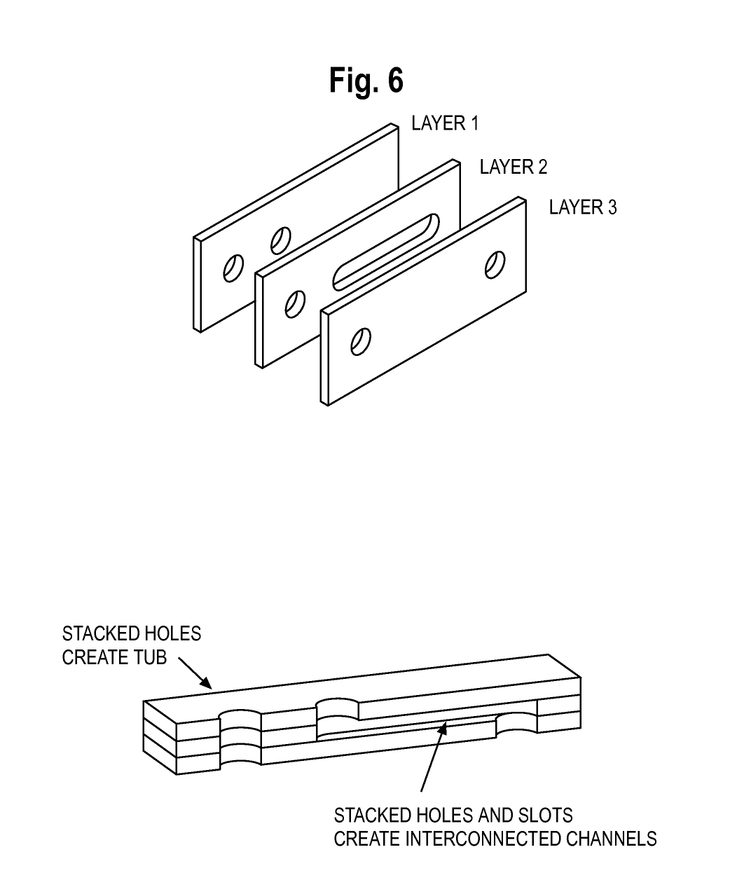

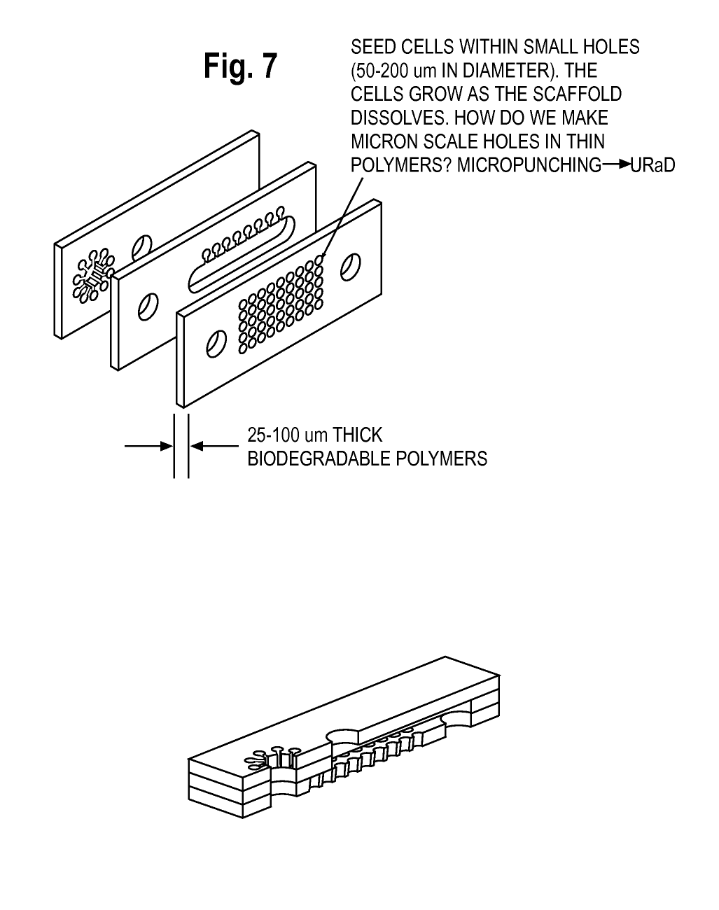

In some cases, it may be more desirable to use metal for die construction, especially in the case of the female die where the through hole features can be cut by a laser. When cutting with a laser, hole quality diminishes as more power is required to cut through a thicker material and the effect of taper angle increases with material thickness, which can limit feature proximity. When micro-machining, small diameter tools can easily fracture due to bending loads and therefore the depth of machining is typically minimized in proportion to feature size. For these reasons, metal plates used for female die construction were typically less than 300 μm thick. A conceptual drawing of a micro-stamping press, with key features identified, is shown in FIG. 4.

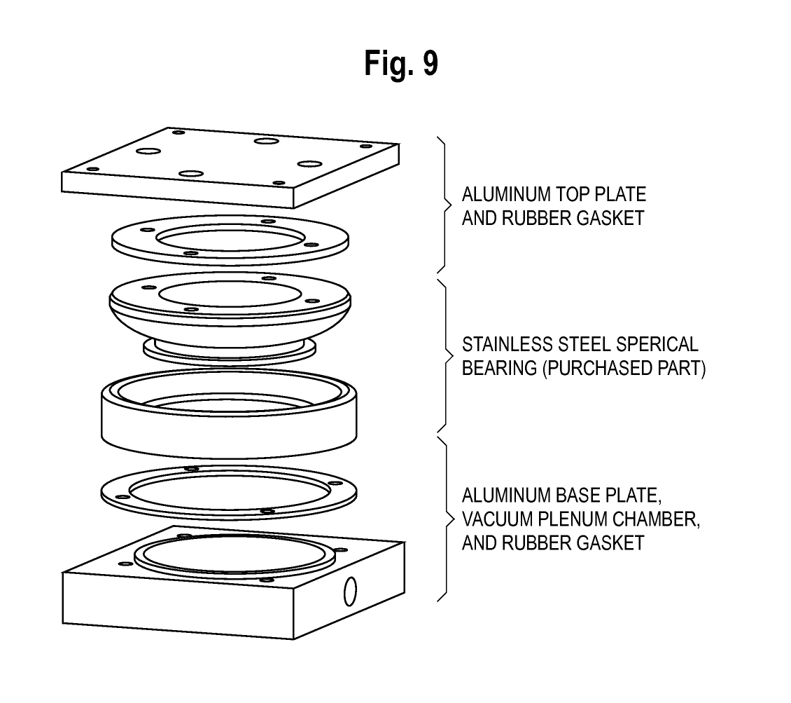

In some embodiments, the micro-stamping machine comprises a spherical bearing that can be locked and unlocked by using vacuum, FIGS. 4 and 9.

In some embodiments, microlaser drilling is used to create the clearance holes in the female die half. Natural hole taper from laser drilling assists in stripping the punch-out, thereby eliminating the need for a stripper plate between the die halves.

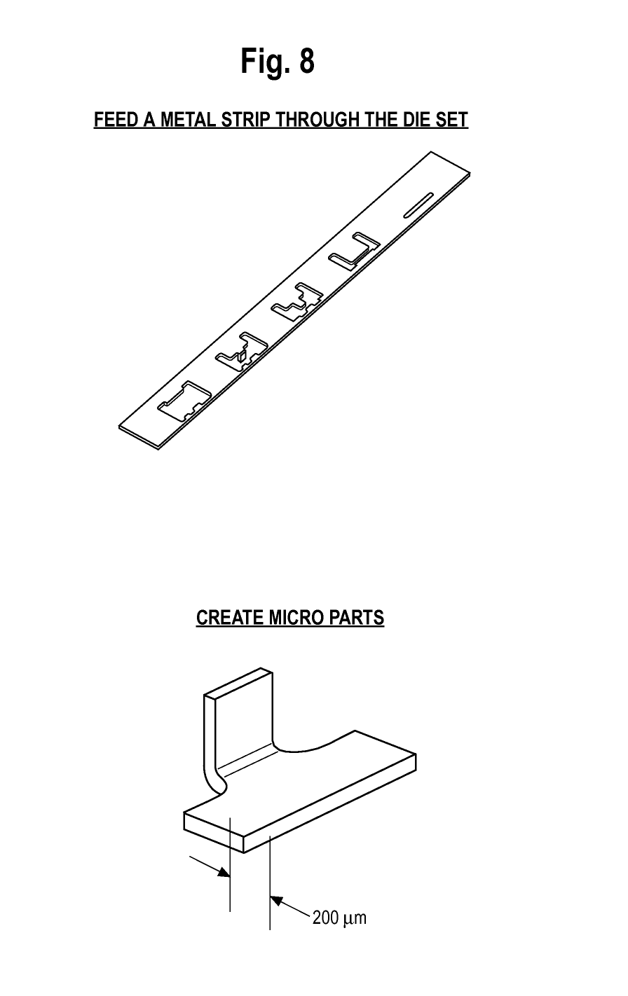

In some embodiments, the punch has single hole or multi-hole capabilities. In some embodiments, the die set uses a series of punches to form trenches or other stretches of cut material. In some embodiments, progressive die set fabrication is utilized (e.g., as described in FIG. 8). In some embodiments, anti-stiction coatings are used to further reduce adhesion of the membrane to die surfaces. In some embodiments, conductive self-assembled monolayers (SAM) are used to prevent in-use stiction due to capillary, van der Waals, and electrostatic forces (Yamashita 2011 Sensors and Actuators A 172, pp. 455-461).

In some embodiments, for alignment of parallel die planes, a “dummy” male die without a protrusion is substituted for the actual male die. With the spherical bearing in the unlocked state, the two die halves are pressed into mating contact. With the dies in firm contact, the vacuum is engaged and the spherical bearing is therefore locked into position, achieving “perfect” parallel alignment between dies.

In some embodiments, precision alignment between features on the male and female die halves is engineered. As a general rule in the sheet metal industry and supported by research in micro-stamping, the one sided clearance between the punch and the hole should be in the range of 3% to 10% of the workpiece thickness. For example, when punching 200 um holes in 25 um thick copper foils, a 10% die clearance would require a difference in radii between the punch and the hole to be 2.5 μm. If the clearance is too small, a higher stamping force is required and the punch tends to show more wear due to burnishing. If the clearance is too large, the degree of material bending and tearing, as compared to the desired amount of shearing, is too large and the final hole can be of poor quality, often exhibiting burrs around the edges.

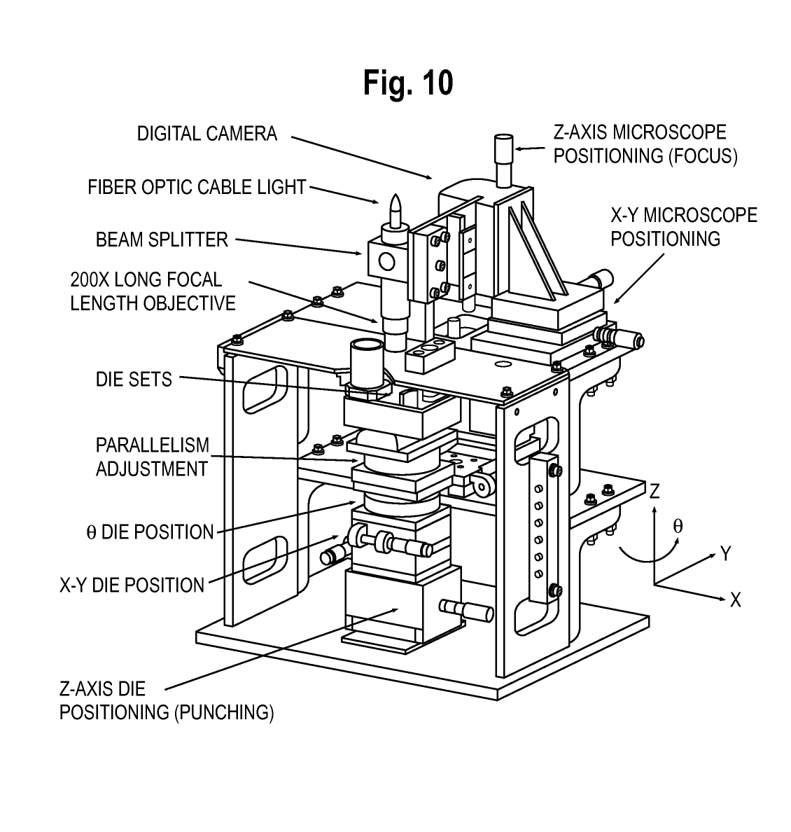

If the die has only one punch and one mating hole, the stamping machine should have precision alignment in the X-Y plane. If the die has more than one punch/hole, there should also be precision angular control, 0, about an axis that is normal to the X-Y plane. The normal axis to the X-Y plane is in the Z direction, which is in the direction of punch movement during stamping, FIG. 10.

Once parallelism between the male and female die halves is achieved and a means of precision X-Y-O control is established, the die sets are aligned to create equal clearance between mating features. There are two methods of controlling die alignment, either active or passive. With passive control, alignment is achieved with pins and holes in the die block that have a relative position to the corresponding punch and hole features in the dies. However, in microscale die design, the conventional machining methods and resulting tolerances are sometimes insufficient to maintain punch to die clearances of less than approximately 10 μm by using guide pin arrangements. Therefore, in some embodiments, an active control method is used where the alignment process is governed by directly observing features on both the male and female dies concurrently and then adjusting one die relative to the other until alignment was achieved while viewing the arrangement real time.

Active control of die alignment can be either direct or indirect. With indirect die alignment, features can be added to the dies that are used exclusively for alignment purposes, but do not engage the workpiece during punching. Consider for example a transparent female die with the geometry of a cross manufactured on one corner by laser cutting, etching, deposition, etc. Likewise, the male die has a cross manufactured in a similar corner. By using a microscope, an operator can look through the female die while moving the male die into position with the X-Y-O stages. Once the two crosses are aligned, the punch and hole on the die are also aligned.

A limitation of the indirect method is that alignment accuracy depends on precision of the relative position of the die punch or hole to the alignment feature. With lithographic processes, it is possible to very accurately control feature to feature distances and sizes so it is possible, for example, to make an alignment cross with micron to sub-micron precision on one die half. The same features on the male die half are manufactured with the same positional and size tolerance on the female die half. This is more difficult because the two die halves may be constructed from different materials and may have different geometries, which can precipitate thermal expansion/contraction differences during processing and use of the die sets.

An alternative method of active die alignment is direct alignment, where the punch is directly observed as it is moved into position within the hole in the female die. In this case, there is no need for additional features on the die set for alignment purposes and the microscope can stay focused at one specific distance.

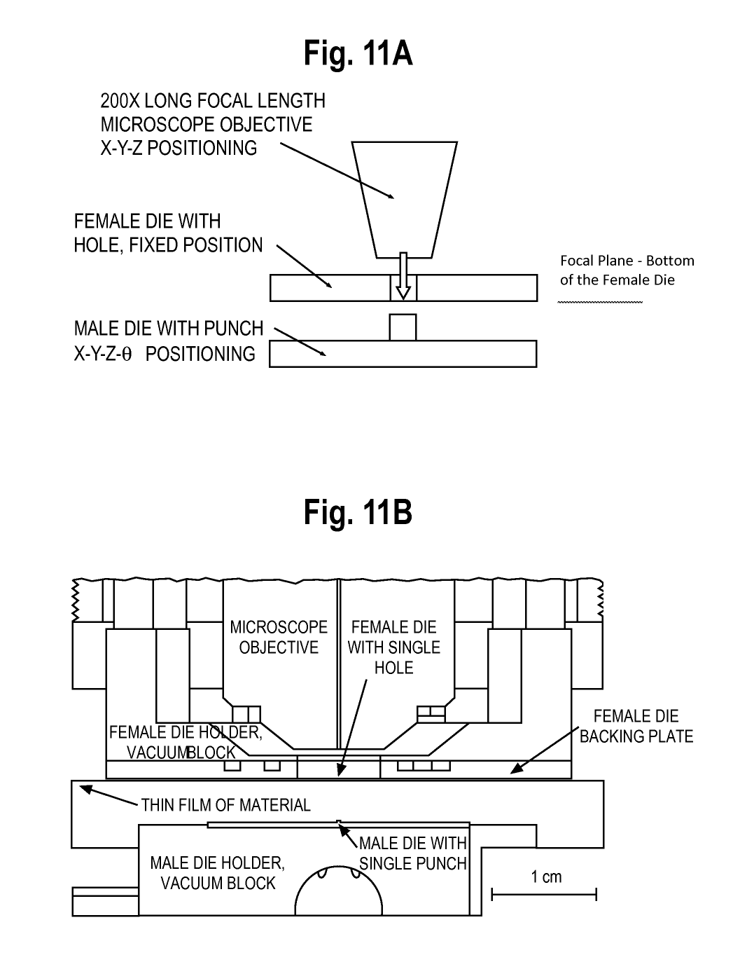

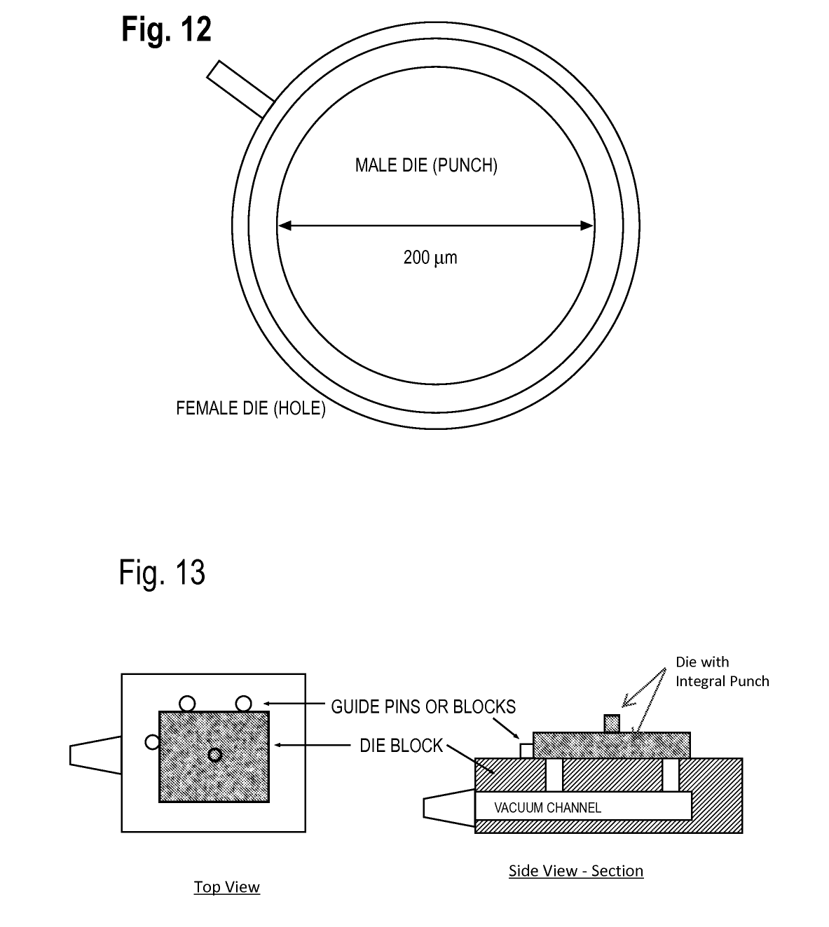

In direct alignment, the position of the microscope is controlled by an additional set of X-Y-Z micro-positioning stages, FIG. 10. By adjusting the focal depth with the Z-axis microscope stage, the field of view was brought into focus at a depth equivalent to the underside of the female die, see “Focal Plane” in FIG. 11. At this point, the punch on the male die was raised into position with the Z-axis die stage while simultaneously adjusting the X-Y position to align the punch in the center of the hole as observed real time on a laptop computer screen with data captured by a digital camera, FIG. 12. If there is more than one hole in the die to be aligned, the microscope is adjusted in the X-Y plane, depending on feature size and the desired magnification.

Securing thin dies to their respective backing plates presents several challenges. Clamping geometry, such as the head of a fastener, must be sub-flush to the surface of the die to prevent interference during stamping operations. The typical practice with thicker metal dies is to counterbore a hole to accommodate the head of the fastener. With thinner dies, there is insufficient thickness for a counterbore. In this case, blocks could be used to clamp the edges of the dies, with the dies oriented to provide clearance. However, in the case of silicon or glass, the dies are brittle and therefore can crack during clamping with blocks.

The issue of securing thin dies to the backing plates was overcome with a unique system that used guide pins or blocks for locating the dies and vacuum to provide a clamping force. The male and female die blocks were manufactured with a series of interconnected holes so that only one vacuum line was required to secure each die, FIG. 13. This method was convenient as it eliminated the need for fasteners or clamping blocks and worked independent of die thickness. Prior to engaging vacuum, the dies were positioned against an orthogonal arrangement of sub-flush guide pins or blocks, FIG. 13.

The workpiece material should be secured between the dies during the stamping operation to prevent movement as the punch is advanced to shear the material and to prevent lift-off as the punch is extracted. In addition, the material that is removed by stamping, e.g., the “punch-out” must be prevented from sticking to the punch so that it does not interfere with the next stamping process. Finally, the workpiece material holder should be capable of moving the material within the die set, for example to form patterns of holes or in the case of a progressive die, to advance the material to the next station.

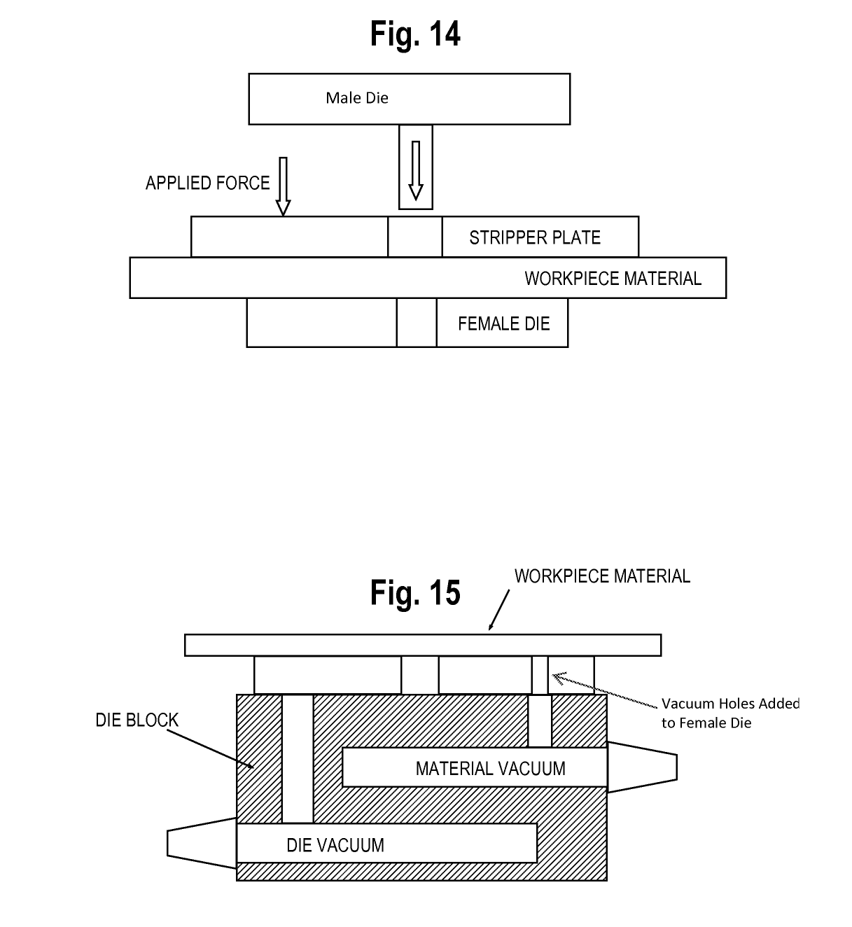

A commonly used method to hold the material in place during punching is to use a “stripper plate.” The stripper plate is placed on top of the workpiece material between the dies. With this design, the punch must be long enough to extend through the stripper plate and slightly beyond the thickness of the workpiece material, FIG. 14.

When creating micro-scale protrusions on the male die to act as punches, it is often difficult to manufacture high aspect ratio micro-scale geometry by lithographic processes. In addition, tall features that have relatively small cross sectional areas fracture easily when subjected to bending forces. For these reasons, short, stocky punches are preferable. Complexity of the die and length of the punch can both be reduced by removing the additional thickness of the stripper plate, but an alternative means must be provided to hold the material in place during the stamping operation.

In the design of the micro-stamping press, the stripper plate was removed. The function of the plate was replaced by two means. First, vacuum holes were added to the female die with accompanying ports in the female die block. The material vacuum porting was separate from the vacuum used to clamp the die in place, FIG. 15.

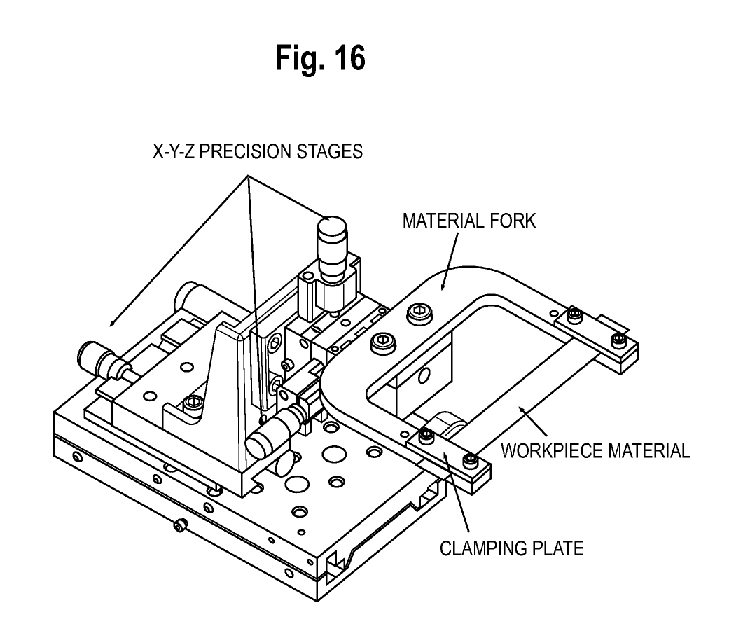

A second means of holding the material in place was established by developing a material holder that moved in the X-Y and Z plane. X-Y movement, which is in the plane of the die, allowed the operator to create patterns of holes or in the case of a progressive die allowed material movement in the feed direction. A material holder was designed with a fork-like appearance, FIG. 16, to provide clearance between the holder and the die blocks. For prototyping and for short runs, material is clamped into place as shown in FIG. 16 or for progressive punching the clamping plates is replaced with rollers to wind and unwind a continuous strip of material.

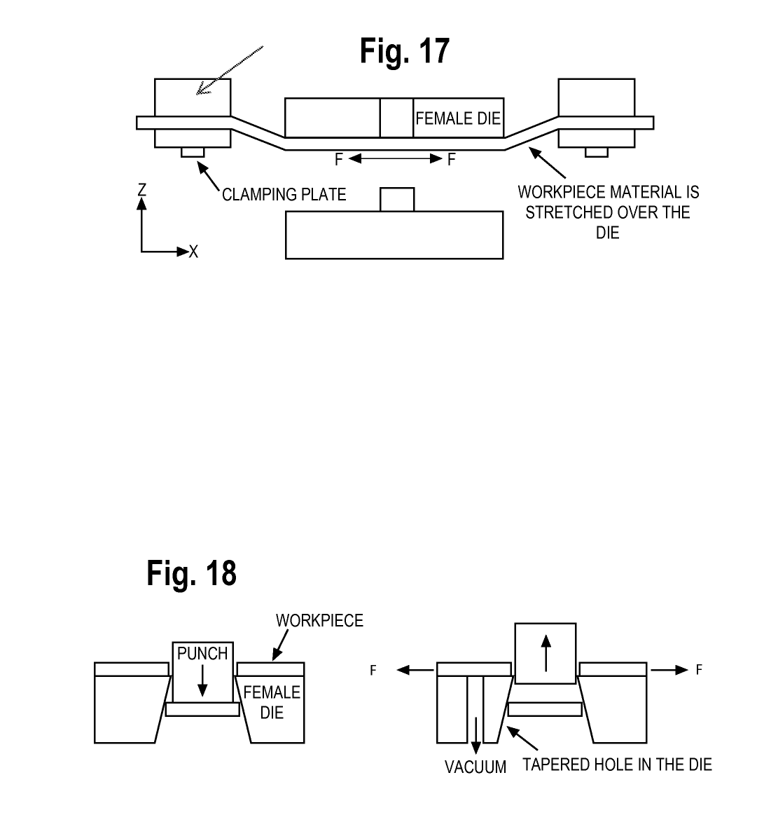

In a traditional stamping die, the material is moved in the X-Y plane of the die. With the addition of Z-axis movement (perpendicular to the plane of the die), in some embodiments, tension is added to the workpiece material as it was stretched over the die, FIG. 17. The tensile force, F, was used to remove any waviness in the material surface prior to stamping. In addition, the tensile force is used independently or concurrently with the vacuum force to keep the material from being lifted off the die as the punch was extracted.

In some embodiments, in order to prevent loose material from sticking to the end of the punch and thereby interfere in successive stamping operations, female die sets that have a 1 to 3 degree taper as shown in FIG. 18 are used. The dies are orientated such that the smaller hole in the female die is adjacent to the material. Once the punch extends through the material, the tapered hole in the female die reduces the likelihood of the punched material from being lifted out of the hole. The taper in the female die holes is created, for example, through lithographic processes, such as reactive ion etching, or if a laser is used to cut the holes, the taper occurs as a natural part of the manufacturing process.

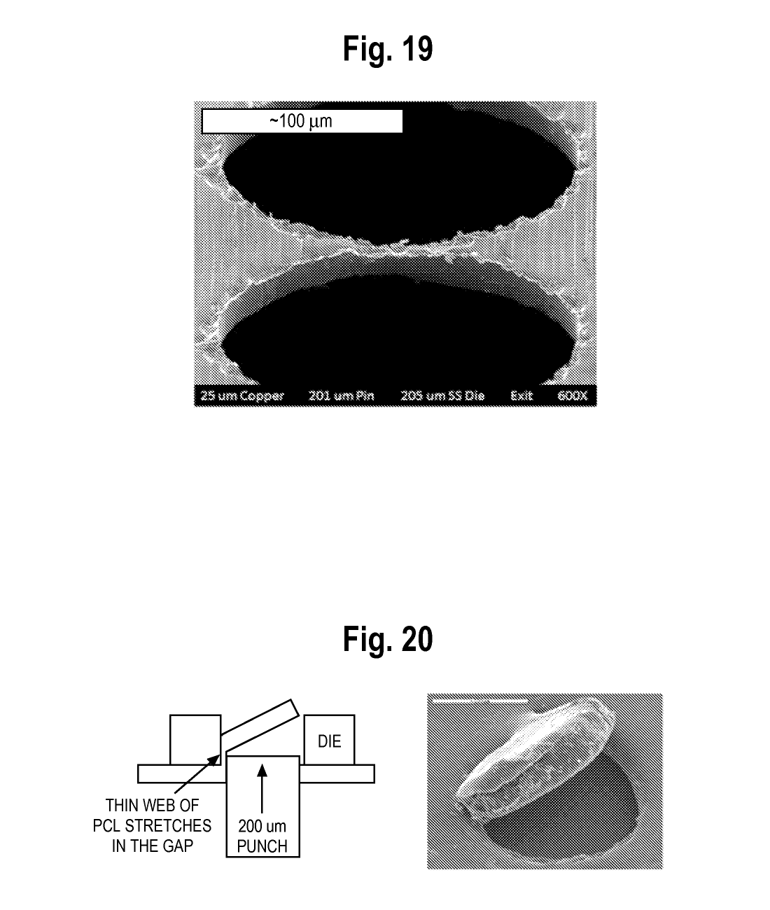

The micro-stamping machine design and the methods employed permitted high density hole patterns to be punched in various materials. For example, the web thickness for adjacent 200 μm diameter holes in 25 μm thick copper foil was reduced to approximately 5 μm to 10 μm, FIG. 19, prior to tearing of the web between holes.

During attempts to micro-punch 200 μm diameter holes in a polymer film (20-40 μm thick poly-caprolactone (PCL)), a problem was observed where the material resisted shear around the complete perimeter of the hole, which left the punch-out hanging by a thin tentacle, FIG. 20.

Reducing the die clearance did not resolve the “hanging chad” issue as PCL exhibited very high elongation to failure. The material continued to stretch into a long thin tab, firmly securing the punch-out to the material surface. Presence of the tab persisted down to a clearance of approximately 2-3%.

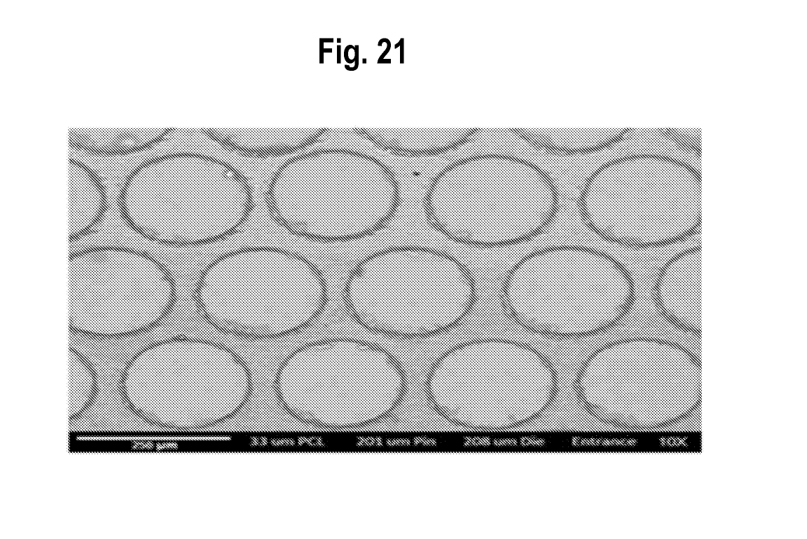

To reduce elongation to failure, the material was cooled with liquid nitrogen (LN2) to below the polymer's glass transition temperature, which was approximately −60 degrees Celsius. At this temperature the material becomes brittle and micro-holes were stamped in the PCL without the issue of a tab forming on the perimeter, even at high die clearances, e.g., greater than 15%, FIG. 21.

To achieve micro-punching of polymers below the glass transition temperature, the die blocks were designed to be cooled by direct contact with LN2. This was done by creating reservoirs for LN2 and insulating the die blocks from the larger metal frame comprising the micro-punching machine. The reservoirs were of sufficient size to permit some loss of LN2 due to boiling while the non-insulated components cooled. An alternate method, however more costly, would be to cool the components with a fully enclosed network of tubes and forced circulation of LN2 by a cryo-pump. Thin polymer films are cooled by contact with the die set, using the Z-axis adjustment on the material stage to lightly stretch the film across the face of the female die as previous shown, FIG. 17.

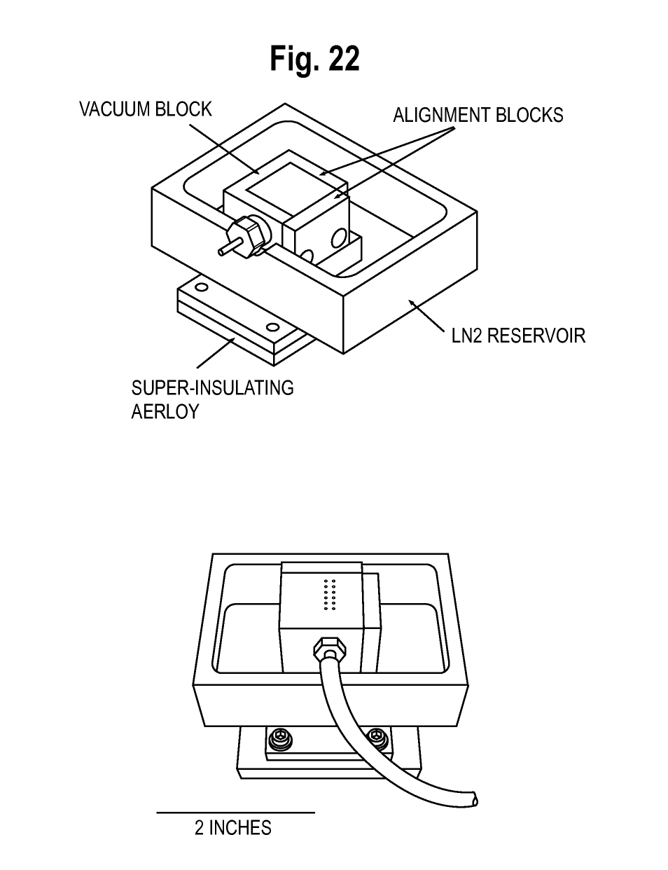

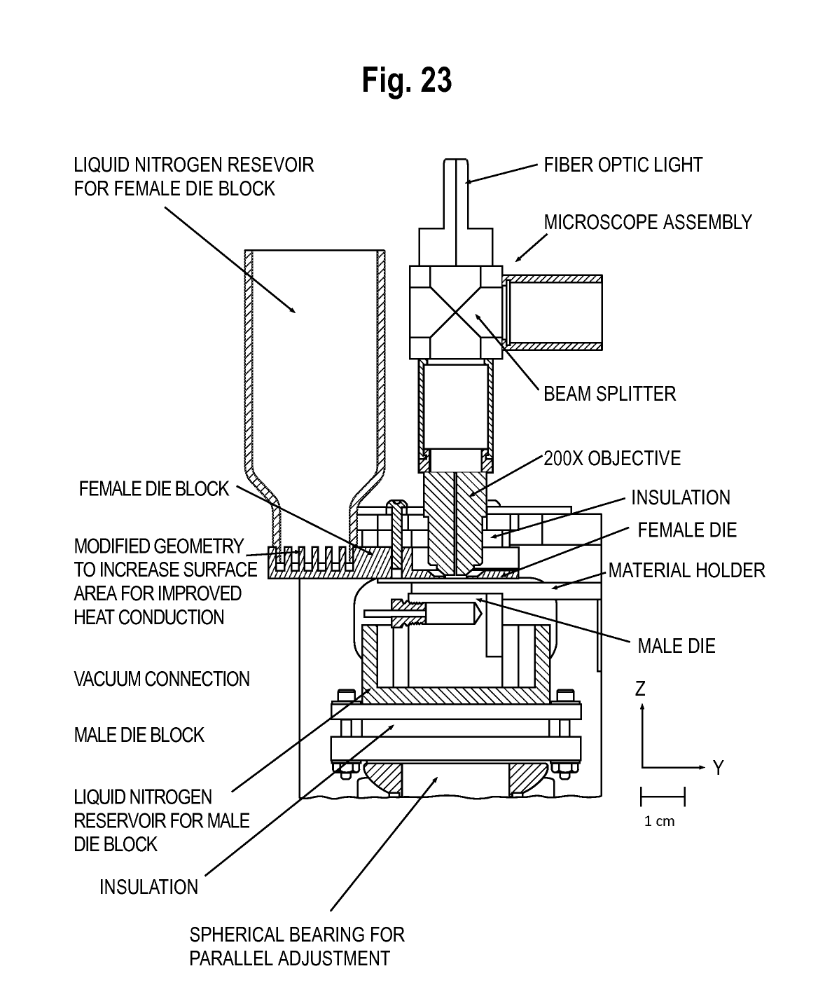

A design and manufactured component for the male die LN2 reservoir is shown in FIG. 22. A section view of the conceptual design for LN2 cooled male and female die blocks is shown in FIG. 23.

An unintended consequence of cooling with liquid nitrogen is the initial condensation of water vapor and the eventual buildup of frost on the system components. Initially, the condensation interferes with clear viewing during microscope alignment of the dies and eventually the buildup of frost interferes with the micro-punching process. To prevent condensation at the dew point, a volume around the die blocks was enclosed with plastic and back-filled with gas, e.g., dry nitrogen gas. In some embodiments, the die block assembly is be enclosed with transparent plastic panels.

The present invention is not limited to the fabrication of a particular material. The micro-punches described herein find use in the fabrication of holes in a variety of materials (e.g., metals, plastics, polymers, tissues, etc.), depending on the use. The devices, systems, and methods described herein find use in improving the capability and efficiency of creating microholes in membranes and benefit several industrial sectors e.g. filters, nozzles, sensors, and valves, micro-electrical packaging applications, and the bioengineering of human muscle, cartilage, bone, and organs.

In one exemplary embodiment, substrates for tissue engineering are generated using the devices and systems described herein. In some embodiments, a hot melt extrusion machine (DSM Xplore, Geleen), is used to create continuous strips of polymeric membranes (e.g., for use in tissue engineering). In some embodiments, a 25 μm thick membrane from polycaprolactone (PCL) is utilized.

Tissue engineering provides an opportunity to develop patient specific implants in vitro by seeding scaffolds with donor cells. Scaffold engineering through multilayer construction is a relatively new field where mircoarchitecture is created by stacking membranes into 3D structures (Engelmayr Nature Materials 7, pp. 1003-1010, 2008, Freed, Advanced Materials 21 (32-33), pp. 3410-3418, 2009, Pappenburg Biomaterials 30, pp. 6228-6239 2009, Park Biomaterials 32, pp. 1856-1864 2011).

Tissue scaffolds have been developed by several methods, which can be divided into two broad categories distinguished by the ability to control (engineer) pore size, geometry, and distribution as well as construction of internal channels. It is not feasible to engineer a mircoarchitecture with conventional methods, such as solvent-casting with particulate leaching, gas foaming, fiber meshes, phase separation, melt molding, emulsion freeze drying, solution casting, and freeze drying. However, there are solid freeform fabrication (SFF) methods that have been used to engineer scaffolds, including 3D printing, stereolithography, fused deposition modeling, and phase-change jet printing. Most SFF methods require an internal support structure that must be dissolved with solvents, where residuals pose a risk of toxicity of seeded cells (Sachlos, European Cells and Materials 5, pp. 29-40 2003). Rapid prototyping methods are being used to produce single- and multi-layered tissue engineering scaffolds that are elastomeric and biodegradable (Engelmayr 2008 Nature Materials 7, pp. 1003-1010, Freed 2009 Advanced Materials 21 (32-33), pp. 3410-3418, Guillemette 2010, Park 2011 Macromolecular Bioscience 10(11), pp. 1330-1337). In general, these methods and the aforementioned SFF methods are time consuming, which is to say it takes hours rather than seconds to produce a single scaffold layer. One underlying reason for manufacturing inefficiency is the pursuit of scaffold material production at the same time as hole creation by rapid prototyping methodologies. The systems and methods of the present disclosure separates these manufacturing processes, for example, by first pursuing high efficiency methods of material production (hot melt extrusion) and then fabricating the hole pattern (micromechanical punching).

There are several persistent issues related to engineered 3D scaffolds through multilayer stacking: 1) Utilizing current manufacturing methods, it is time consuming to create layers with prescribed hole patterns (Mi 2006, Polymer 47, pp. 5124-5130; Engelmayr 2008, supra; Freed 2009, supra; Guillemette 2010, Park 2011, supra); 2) It is difficult to stack layers with precise alignment in order to create a 3D mircoarchitecture (e.g. vascular network) (Engelmayr 2008, supra; Freed 2009, supra; Papenburg 2009, supra; Biomaterials 30, pp. 6228-6239; Park 2011, supra); 3) The desire to increase membrane porosity, to provide more surface area for cell home sites and improved diffusional permeability, results in a reduction of stiffness and strength of the underlying construct (Hutmacher 2000, J Biomater Sci Polym Ed 12, pp. 107-124) Supplying nutrients to the interior layers of a 3D scaffold becomes increasingly difficult as cells produce extracellular matrix, clogging pores and reducing mass transfer of nutrients (Vidaurre 2007 Journal of Non-Crystalline Solids 353, pp. 1095-1100).

The devices and methods of the present disclosure solve the above problems. The first problem is addressed directly with the microstamping process. The second problem is addressed in some embodiments by a folding process of single membrane layers with active cell communities as an alternative approach to aligned stacking in manufacturing a multilayered scaffold. The last two problems are inherent to scaffold fabrication by the aligned stacking method. The micromechanical punch described herein finds use in the fabrication of long strips of porous membranes suitable for seeding and subsequent folding.

PCL is an aliphatic polymer with a low glass transition temperature of negative 60 Celsius and a low melting temperature of approximately 59-64 Celsius. It has been successfully used as a cartilage and bone scaffold (Williams 2005, Biomaterials 26, pp.4817-27; Tay 2007, J. Mat. Proc. Tech., 182, pp. 117-121) and recently described as the most flexible among the synthetic biodegradable polymers for ease of processing (Tay 2007, supra). PCL scaffolds have been rapid prototyped by precision extrusion deposition and successfully blended with hydroxyapatite (HA) (Shor 2006, Proc. IEEE, 32^{nd} Annual Northeast Bio. Conf. pp. 73-74), which is chemically similar to the mineral constituent of bone and can also provide mechanical strength.

The hydrophobic nature of PCL is ideal for minimizing adhesion due to moisture on die surfaces, but can also make it difficult for cell adhesion during seeding. However, the surface of PCL has recently been modified with the Arg-Gly-Asp (RGD) peptide to significantly improve bone marrow stromal cell adhesion (Zhang 2009, Biomaterials, 30(25), pp. 4063-4069). PCL powder and pellets are low cost and readily available from several suppliers.

In one exemplary experiment, poly(ε-caprolactone) (PCL) of 25 μm to 50 μm thickness was used to made holes of 25 μm to 200 μm.

All publications and patents mentioned in the above specification are herein incorporated by reference as if expressly set forth herein. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in relevant fields are intended to be within the scope of the following claims.

1. A microforming device, comprising:
An integrated two piece die set comprising a punch lithographed component and a hole lithographed component.

2. The device of claim 1, wherein said punch component is configured from glass, silicon, or metal.

3. The device of claim 1, wherein said punch and/or hole components are coated with an anti-stiction coating and/or anti-wear coating.

4. The device of claim 3, wherein said anti-stiction coating is a self-assembled monolayer.

5. The device of claim 1, wherein said micro-punch comprises an alignment component.

6. The device of claim 5, wherein said alignment component comprises marking for optical alignment.

7. The device of claim 6, wherein said die set is configured to align by viewing said marking by looking through a hole in the female die as the male punch is moved into proper alignment.

8. The device of claim 1, wherein said die block is configured to produce one or more holes simultaneously.

9. The device of claim 8, wherein said die block is configured to produce two or more holes simultaneously.

10. The device of claim 8, wherein said die block is configured to produce 5 or more holes simultaneously.

11. The device of claim 8, wherein said two or more holes are 100 μm or less apart.

12. The device of claim 8, wherein said two or more holes are 25 μm or less apart.

13. The device of claim 1, further comprising a liquid nitrogen cooling component.

14. A method of fabricating a material, comprising: contacting a material with the die block of claim 1 under conditions such that said die block generates one or more holes in said material.

15. The method of claim 14, wherein said material is selected from the group consisting of silicon, plastic, metal, and tissue.

16. The method of claim 15, wherein said material is polycaprolactone (PCL).

17. The method of claim 16, wherein said material is a substrate for cell or tissue growth.

18. The method of claim 15, wherein said metal is an electrical connector.

19-20. (canceled)

21. A method of manufacturing a die set, comprising:
a) removing material from a first substrate using a lithographic technique to generate a male die; and
b) removing material from a second substrate using a lithographic technique to generate a female die.

22. The method of claim 21, wherein said substrate is selected from the group consisting of metal, glass, and silicon.

23. (canceled)
